(19) United States
(12) Patent Application Publication
(10) Pub. No.: US 2015/0249929 A1
(43) Pub. Date: Sep. 3, 2015

(54) WIRELESS COMMUNICATION METHOD AND WIRELESS COMMUNICATION SYSTEM

(71) Applicant: Panasonic Corporation, Osaka (JP)

(72) Inventors: MASATAKA IRIE, Kanagawa (JP); YOSHIO URABE, Nara (JP)

(21) Appl. No.: 14/630,210

(22) Filed: Feb. 24, 2015

(30) Foreign Application Priority Data
Feb. 28, 2014 (JP) 2014-039682

(51) Int. Cl. H04W 16/28; H04B 15/00

(52) U.S. Cl. CPC H04W 16/28; H04B 15/00

(57) ABSTRACT

A wireless communication method for performing communication between a respective plurality of base stations and a corresponding plurality of terminal stations, each base station having a plurality of beams and being capable of switching the plurality of beams, including selectively switching a combination of beams used by the respective base stations among a plurality of combinations of beams and transmitting, synchronously and sequentially, training frames to the plurality of terminal stations, storing information representing the plurality of combinations of beams for the plurality of base stations based on a result of reception of the training frames, and selecting, from the stored information representing the combinations of beams for the plurality of base stations, a combination of beams that provides a best overall performance of the plurality of base stations, and allowing it to perform communication to be performed between the plurality of base stations and corresponding terminal stations.

### BACKGROUND

1. Technical Field

The present disclosure relates to a wireless communication method and a wireless communication system.

2. Description of the Related Art

It is known to perform wireless communication using a millimeter wave in a frequency range from 30 GHz to 300 GHz. For example, in Japan, four channels are assigned at 58.32 GHz, 60.48 GHz, 62.64 GHz, and 64.80 GHz (each represented by center frequency) in a 60 GHz band. FIG. 24 is a diagram illustrating frequencies assigned to the respective channels in the 60 GHz band.

Standards for wireless communication using the 60 GHz band include, for example, IEEE (The Institute of Electrical and Electronics Engineers, Inc.) 802.11ad (see, for example, IEEE802.11ad-2012). This wireless communication standard supports wireless transmission at a transmission rate higher than Gbps, which may be used, for example, to transfer a file from a terminal to a television set, transmit image data, or the like, or may be used in interface signal transmission from a notebook personal computer to a function expansion unit of the notebook personal computer.

In the communication using a millimeter wave, by nature of its extremely high frequency, a large transmission loss occurs. Furthermore, its nature of propagating straight results in a further large transmission loss in non line of sight communication, which makes it difficult to achieve a long transmission distance. On the other hand, in the communication using the millimeter wave, the small wavelength of the millimeter wave makes it possible to use a small-size high-gain antenna, and thus it is possible to use the antenna gain to compensate for a transmission loss thereby increasing the transmission distance.

The high-gain antenna can have high directivity by concentrating electric power in a particular direction. Therefore, beam forming is used to control the antenna directivity such that good communication is allowed in a particular direction. In the IEEE802.11ad standard (IEEE802.11ad-2012), it is assumed to use the beam forming, and the standard includes a prescription of a method of beam forming training to select an optimum beam. The beam forming training is performed between a base station and a terminal station.

FIG. 25 is a diagram illustrating a conventional method of beam forming training. In FIG. 25, a beam is swept by way of example in six directions. A base station (also referred to as an access point (AP) or a personal basic service set control point (PCP) 100 transmits training frames to a terminal station (also referred to as STA) 110 of interest while sweeping the beam in six directions. Through the beam forming training, the base station detects an optimum beam and stores information indicating the optimum beam. After the beam forming training is completed, the base station performs communication with the terminal station 110 using the optimum beam indicated by the stored information (hereinafter also referred to simply as the stored beam). Note that the terminal station will also referred to as STA or non-PCP/AP STA.

FIG. 26 is a flow chart illustrating the conventional method of beam forming training. As illustrated in FIG. 26, a base station starts beam forming training with a terminal station of interest, and sets a beam number #N to 1 (#N=1) (step S100). Next, a training frame is transmitted to the terminal station using a beam with a beam number “1” (step S101).

After the base station transmits the training frame using the beam with the beam number “1”, the base station determines whether this beam number is a last one (step S102). In a case where the base station determines that the beam number is not the last one (that is, in a case where the answer to step S102 is “No”), the base station increments the beam number such that #N=#N+1 (step S103). Thereafter, the base station returns the processing flow to step S101, and the base station transmits a training frame using a beam with a next beam number.

The base station performs the process from step S101 to step S103 repeatedly until the last beam number is reached. In a case where the base station determines in step S102 that the beam number is the last one (that is, in a case where the answer to step S102 is “Yes”), the base station stores a beam number that resulted in best communication quality (step S104). The base station then selects the stored beam number and starts communication with the terminal station of interest using the beam with the selected beam number (step S105).

The communication quality may be expressed by, for example, a signal to noise ratio (SNR), a received signal strength indicator (RSSI), or the like. In the above-described process, the base station performs beam forming training with the terminal station of interest sequentially switching the beam starting with the beam with the first beam number until the beam forming training using the beam with the last beam number is completed, and the base station selects a beam number that resulted in the best communication quality. The base station then performs communication with the terminal station of interest using the beam with the selected optimum beam number.

### SUMMARY

In a case where communication is performed between a plurality of base stations and a plurality of terminal stations using a plurality of channels at the same time, there is a possibility that interference occurs between adjacent channels. However, in the conventional method of beam forming training, an optimum beam number is selected by the base station based on the communication quality in communication with the terminal station via a single channel, and thus it is difficult to prevent interference between adjacent channels.

That is, in the conventional method, the selection of a beam via the beam forming training is performed based on SNR or RSSI in communication between the base station and the terminal station that are participating in the beam forming training so as to achieve best SNR or RSSI between the base station and the terminal station without taking into account an influence (an adverse effect) on other terminal stations using other channels. Therefore, when the conventional method of beam forming training is used, there is a possibility that it is difficult to achieve high-quality communication.

FIG. 27 is a diagram illustrating an example of interference between two communication areas. In FIG. 27, a channel Ch1 is used by a pair #1 of a base station 100-1 and a terminal station 101-1, and an adjacent channel Ch2 is used by a pair #2 of a base station 100-2 and a terminal station 101-2. There is an area in which overlapping occurs between the communication area of the pair #1 and the communication area of the pair #2, and thus interference may occur in this area.

The base station 100-1 and the terminal station 101-1 in the pair #1 (Ch1 in FIG. 27) perform the beam forming training, and the terminal station 101-1 detects a beam that provided highest SNR or RSSI as a result of the beam forming training and determines the detected beam as the optimum beam. The terminal station 101-1 notifies the base station 100-1 of the determined optimum beam. Based on the result notified from the terminal station 101-1, the base station 100-1 uses the optimum beam, detected by and notified from the terminal station 101-1, in following communication.

However, in a case where the beam determined by the terminal station 101-1 as the optimum beam based on the result of the beam forming training is a beam that causes interference with communication of the pair #2 and thus that is improper for actual use in communication, it is difficult to perform communication using channel Ch1 or the channel Ch2. This results in a reduction in a limited frequency resource (for example, the pair #1 does not know whether the pair #2 is performing communication when the beam forming training is being performed).

One non-limiting and exemplary embodiment provides a wireless communication method capable of suppressing interference between adjacent channels even when communication is performed simultaneously between a plurality of base stations and a plurality of terminal stations using a plurality of channels, thereby making it possible to achieve high-quality communication.

In one general aspect, the techniques disclosed here feature that a wireless communication method for performing communication between a respective plurality of base stations and a corresponding plurality of terminal stations, each base station having a plurality of beams and being capable of switching the plurality of beams, the method including selectively switching a combination of beams used by the respective base stations among a plurality of combinations of beams and transmitting, synchronously and sequentially, training frames to the plurality of terminal stations, storing information representing the plurality of combinations of beams for the plurality of base stations based on a result of reception of the training frames, and selecting, from the stored information representing the combinations of beams for the plurality of base stations, a combination of beams that provides a best overall performance of the plurality of base stations, and allowing it to perform communication to be performed between the plurality of base stations and corresponding terminal stations.

Thus the present disclosure provides makes it possible to suppress interference between adjacent channels even when communication is performed simultaneously between a plurality of base stations and a plurality of terminal stations using a plurality of channels, thereby making it possible to achieve high-quality communication.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating a configuration of a wireless communication system according to an embodiment;

FIG. 2 is a diagram illustrating examples of combinations of beam patterns;

FIG. 3 is a diagram illustrating a relationship between base stations and terminal stations in a wireless communication system according to an embodiment;

FIG. 4 is a diagram illustrating a beam forming sequence performed in a wireless communication system according to an embodiment;

FIG. 5 is a diagram illustrating an example of interference between two communication areas;

FIG. 6 is a diagram illustrating an example of a response frame;

FIG. 7 is a diagram illustrating an example of a performance in terms of a bit error rate vs. SNR in BPSK;

FIG. 8 is a flow chart illustrating a method of beam forming training performed in a wireless communication system according to an embodiment;

FIG. 9 is a diagram illustrating an example of an effect compared with that obtained in a conventional wireless communication system;

FIG. 10 is a diagram illustrating an example of an effect compared with that obtained in a conventional wireless communication system;

FIG. 11 is a diagram illustrating an example of an effect compared with that obtained in a conventional wireless communication system;

FIG. 12 is a diagram illustrating an example of an effect compared with that obtained in a conventional wireless communication system;

FIG. 13 is a diagram illustrating a method of performing beam forming training in a wireless communication system according to an embodiment;

FIG. 14 is a diagram illustrating a method of performing beam forming training in a wireless communication system according to an first example of an application of an embodiment;

FIG. 15 is a diagram illustrating a method of performing beam forming training in a wireless communication system according to an second example of an application of an embodiment;

FIG. 16 is a diagram illustrating a method of performing beam forming training in a wireless communication system according to an third example of an application of an embodiment;

FIG. 17 is a diagram illustrating a method of performing beam forming training in a wireless communication system according to an third example of an application of an embodiment;

FIG. 18 is a diagram illustrating a method of performing beam forming training in a wireless communication system according to an fourth example of an application of an embodiment;

FIG. 19 is a diagram illustrating a method of performing beam forming training in a wireless communication system according to an fourth example of an application of an embodiment;

FIG. 20 is a diagram illustrating a method of performing beam forming training in a wireless communication system according to an fourth example of an application of an embodiment;

FIG. 21 is a diagram illustrating a method of performing beam forming training in a wireless communication system according to an fourth example of an application of an embodiment;

FIG. 22 is a block diagram illustrating a configuration of a first example of a modification of a wireless communication system according to an embodiment;

FIG. 23 is a block diagram illustrating a configuration of a second example of a modification of a wireless communication system according to an embodiment;

FIG. 24 is a diagram illustrating frequencies assigned to respective channels in a 60 GHz band;

FIG. 25 is a diagram illustrating a conventional method of performing beam forming training;

FIG. 26 is a flow chart illustrating a conventional method of performing beam forming training;

FIG. 27 is a diagram illustrating an example of interference between two communication areas;

FIG. 28 is a diagram illustrating a spectrum mask prescribed in IEEE802.11ad;

FIG. 29 is a diagram illustrating channels assigned to a 2.4 GHz band;

FIG. 30 is a diagram illustrating an example in which channels Ch2 and Ch4 are not used in a 60 GHz band;

FIG. 31 is a diagram illustrating a beam forming sequence using SLS; and

FIG. 32 is a diagram illustrating an example of a structure of a frame for beam forming training using a SSW frame.

### DETAILED DESCRIPTION

Embodiments of the present disclosure are described below with reference to drawings.

### Underlying Knowledge Forming Basis of the Present Disclosure

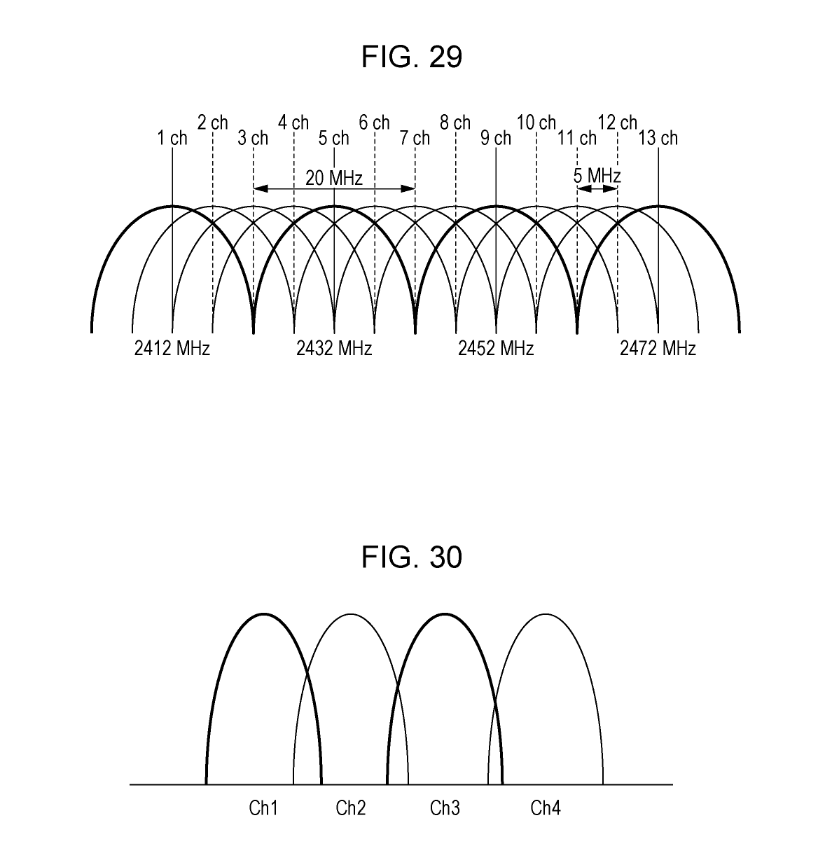

FIG. 28 is a diagram illustrating a spectrum mask prescribed in IEEE802.11ad. In a case where the spectrum mask is used, leakage of power to adjacent channels occurs, and thus interference or crosstalk may occur when adjacent channels are used at the same time. For the same reason, for example, also the 2.4 GHz band according to in 802.11b or 802.11g, interference occurs when adjacent channels are used at the same time. FIG. 29 is a diagram illustrating channels assigned to the 2.4 GHz band. However, in the case of the 2.4 GHz band, there are as many as 13 channels, and thus it is possible to avoid interference and crosstalk by allowing only non-adjacent channels to be used. Note that more precisely, a channel Ch14 exists in a far apart band.

In the 60 GHz band, as described above, a total of 4 channels are allowed to be used. Therefore, if every other channels are used to avoid interference between adjacent channels, only up to 2 channels of 4 channels are allowed to be used at the same time without having interference, which results in a reduction in the total throughput of the system. FIG. 30 is a diagram illustrating an example in which channels Ch2 and Ch4 are not used.

An example of a method of avoiding interference is to use a spectrum mask configured to prevent interference between adjacent channels. Another example of a method is to use a modulation method robust against to interference. However, both methods result in an increase in size and/or power consumption of a wireless communication apparatus or a modem, and thus these methods are discarded in the process of establishing the standard.

IEEE802.11ad prescribes a procedure of beam forming training using, for example, SLS (Sector Level Sweep), BRP (Beam Refinement Protocol), and BeamTracking. In this method, a base station sweeps a transmission beam and continuously transmits frames. For example, in the case of SLS, a plurality of SSW (Sector Sweep) frames are successively transmitted. The space between transmission frames is defined by SBIFS (Short Beamforming Interframe Space=1 μs).

When MBIFS (Medium Beam forming Interframe Space=9 μs) has elapsed since the end edge of a last one of the SSW frames transmitted from the base station, then, in response, the terminal station sweeps a transmission beam and successively transmits a plurality of SSW frames Each SSW frame used in response includes a SSW FeedBack field in which reception quality information on the frames transmitted, while being swept, from the base station is described.

The base station receives the SSW frames from the terminal station. After MBIFS has elapsed, the base station responds using a SSW-FB (Sector Sweep FeedBack) frame. The reception quality information includes a beam number of a beam determined on the terminal station side as being the best beam and SN ratio information of the received beam. That is, one pair of beam number and SNR (Signal to Noise Ratio) are notified. Note that the criterion for detecting the best beam depends on the implementation and is not prescribed.

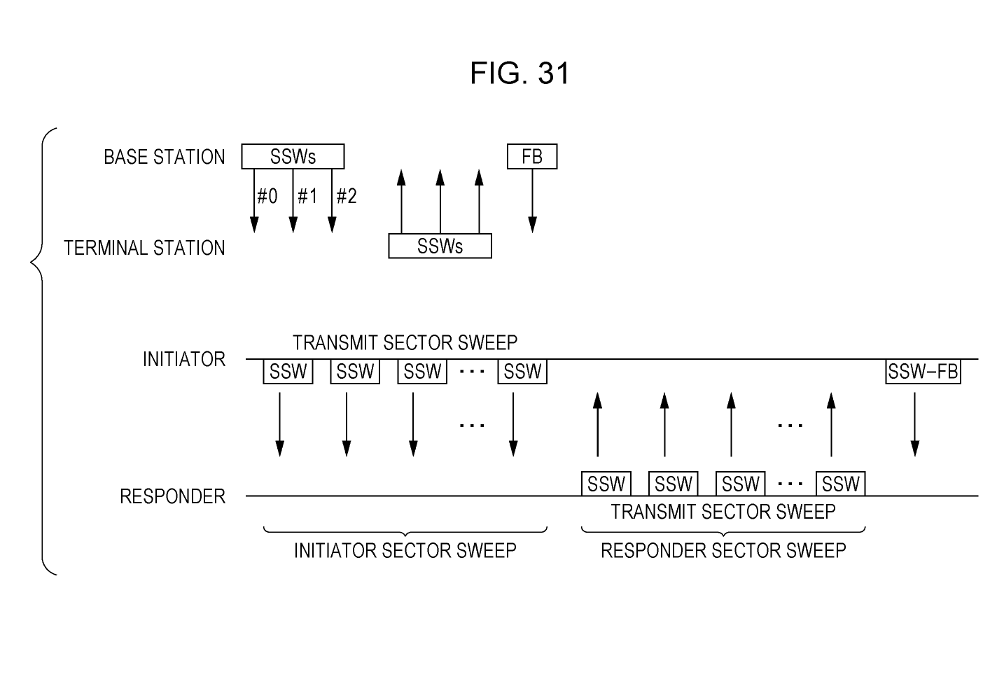

FIG. 31 is a diagram illustrating a beam forming sequence using SLS (Sector Level Sweep). In FIG. 31, INITIATOR represents a side at which training is started, and RESPONDER represents a station at which training is performed in response to the start of the training. Note that either the base station or the terminal station may play the role of either the initiator or the responder.

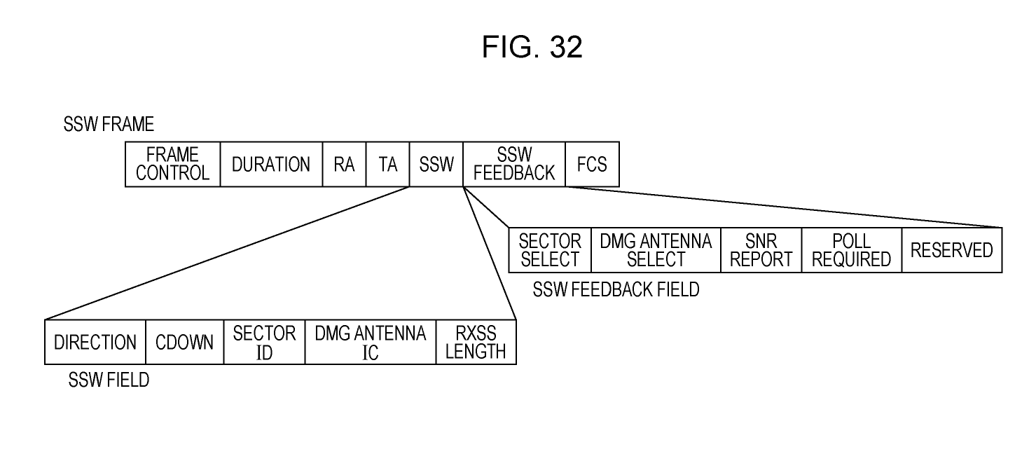

FIG. 32 is a diagram illustrating an example of a structure of a frame for use in beam forming training using a SSW frame. In FIG. 32, a SSW field mainly includes information about a beam swept by a station that transmits the SSW frame. A SSW Feedback field includes mainly information that reports a result of reception of a radio wave of the swept beam. The base station detects a beam optimum for communication (transmission in this case) with the terminal station with which the beam forming training was performed, and the optimum beam is used in communication performed after the training.

In this situation, if a plurality of channels are used at the same time, by nature of the prescribed spectrum mask, interference between adjacent channels occurs. However, the beam selection via the procedure of the beam forming training depends on SNR or RSSI between the base station and the terminal station participating in the beam forming training, and thus only the beam that is optimum between the base station and the terminal station is detected without taking into account an influence (an adverse effect) on other terminal stations using other channels. That is, the optimum beam is selected based on the evaluation on the result of the measurement of quality of communication with the station using the single channel.

Next, a description is given below as to a wireless communication method and a wireless communication system capable of suppressing interference between adjacent channels even when a plurality of channels are used at the same time between a plurality of base stations and a plurality of terminal stations thereby providing high-performance communication.

### EMBODIMENTS

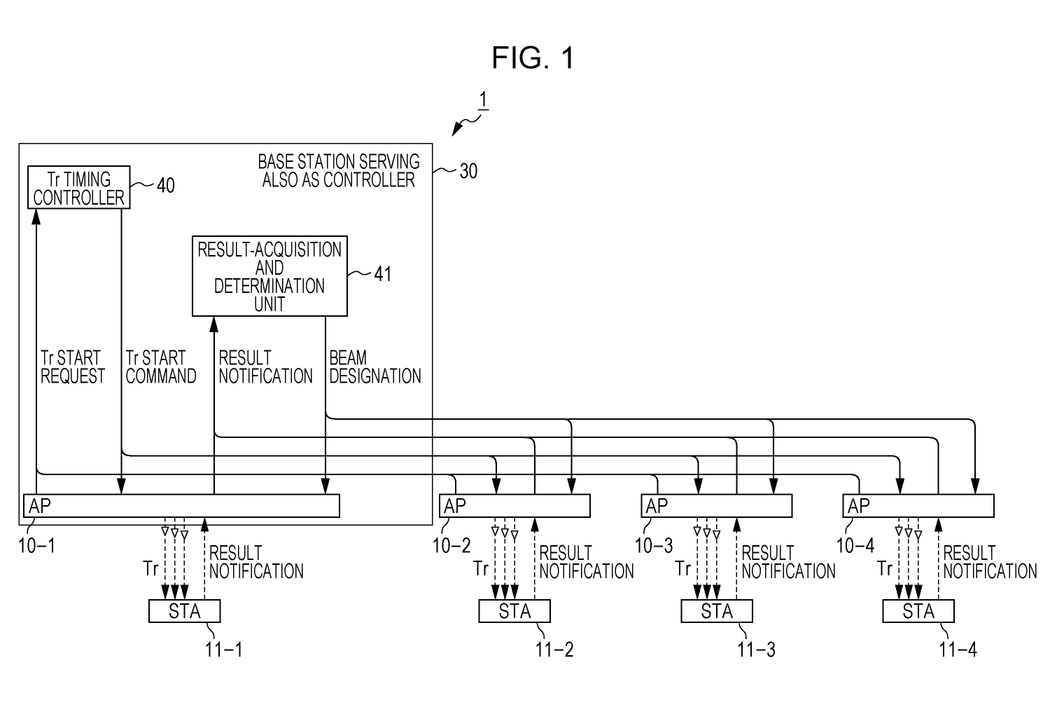

FIG. 1 is a block diagram illustrating a configuration of a wireless communication system according to an embodiment. In FIG. 1, the wireless communication system 1 according to the embodiment operates by using mainly a frequency band equal to or higher than the millimeter wave, and communication is allowed between respective four base stations 10-1 to 10-4 each having three beams and being capable of switching the three beams and corresponding four terminal stations 11-1 to 11-4. Of the four base stations 10-1 to 10-4, the base station 10-1 includes a unit (a control unit) that performs beam forming training between the four base stations 10-1 to 10-4 including the base station 10-1 itself and the four terminal stations 11-1 to 11-4 and sets optimum beams for the respective four base stations 10-1 to 10-4.

The base station 10-1 includes a control unit 30 including a Tr timing controller 40 and a result-acquisition and determination unit (corresponding to a storage unit, a communication unit, and a transmission unit) 41 whereby setting optimum beams. The Tr timing controller 40 selectively switches the plurality of combinations of beams and transmits, synchronously and sequentially, training frames to the four terminal stations 11-1 to 11-4.

Based on a result of reception of training frames at the four terminal stations 11-1 to 11-4, the result-acquisition and determination unit 41 stores information representing a combination of beams that provides a best overall performance of the four base stations 10-1 to 10-4. The result-acquisition and determination unit 41 selects, from the stored information, the combination of beams that provides the best overall performance of the four base stations 10-1 to 10-4 such that communication between the respective four base stations 10-1 to 10-4 and the corresponding four terminal stations 11-1 to 11-4 is allowed using the selected combination of beams.

The base station 10-1 outputs a Tr start request to the Tr timing controller 40 of the control unit 30 provided in the base station 10-1 thereby requesting the Tr timing controller 40 to start the beam forming training. In response to the Tr start request received from the base station 10-1, the Tr timing controller 40 outputs a Tr start command to the base station 10-1. On receiving the Tr start command, the base station 10-1 starts the beam forming training. On receiving the Tr start command, the base station 10-1 starts the beam forming training. The base station 10-1 also receives a command specifying a beam pattern to be used from the result-acquisition and determination unit 41 and performs communication using the specified beam pattern. After transmitting the training frames, the base station 10-1 receives a result notification from the terminal station 11-1.

The Tr timing controller 40 of the base station 10-1 also receives Tr start request from the other base stations 10-2 to 10-4 and outputs Tr start commands to the base stations 10-2 to 10-4. The result-acquisition and determination unit 41 of the base station 10-1 outputs a beam designation command to each of the other base stations 10-2 to 10-4 and receives a result notification from each of the base stations 10-2 to 10-4.

The beams used by the respective base stations 10-1 to 10-4 are determined according to the result of the beam forming training. The base stations 10-1 to 10-4 each have three beam patterns, and thus the number of possible combinations of beam patterns for the four base stations 10-1 to 10-4 is given by 3⁴=81.

In a case where there are 8 beam patterns, the number of combinations of beam patterns is 8⁴=4096. In a case where the number of beam patterns is different among the base stations 10-1 to 10-4, For example, in a case where the base station 10-1 has one beam pattern, the base station 10-2 has three beam patterns, the base station 10-3 has five beam patterns, and the base station 10-4 has seven beam patterns, then the number of combinations of beam patterns is 1×3×5×7=105. In the case where the number of beam patterns is three, each of the base stations 10-1 to 10-4 sequentially switches the 81 beam patterns.

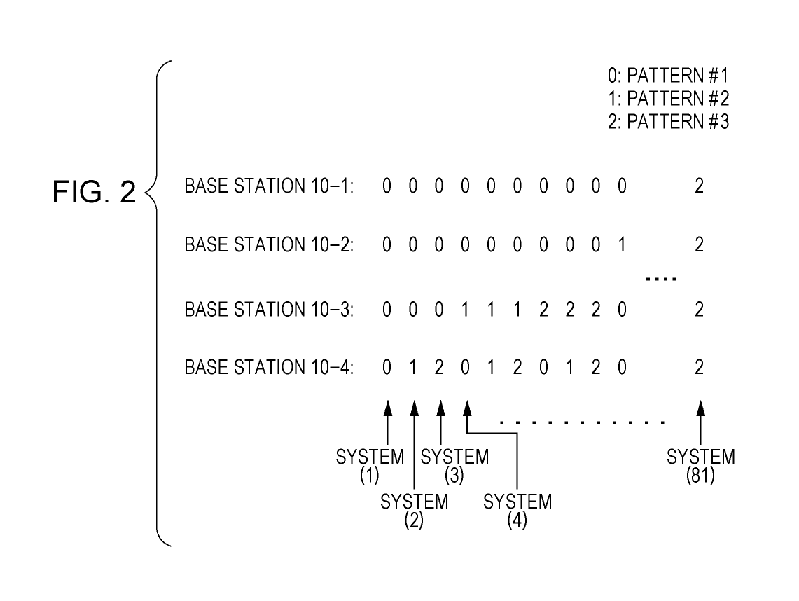

FIG. 2 is a diagram illustrating a total of 81 combinations of beam patterns. For example, a first combination, system(1), is (0000) in which the pattern combination is switched such that the four base stations 10-1 to 10-4 all have a pattern #1. A second combination, system(2), is (0001) in which the pattern combination is switched such that the three base stations 10-1 to 10-3 all have the pattern #1 and the remaining one base station 10-4 has a pattern #2. A next combination, system(3), is (0002) in which the pattern combination is switched such that the three base stations 10-1 to 10-3 all have the pattern #1 and the remaining one base station 10-4 has a pattern #3. Note that the beam patterns (that is, beam shapes) selected at the respective base stations 10-1 to 10-4 may be different among base stations. Furthermore, the number of beams selected may be different among the base stations 10-1 to 10-4.

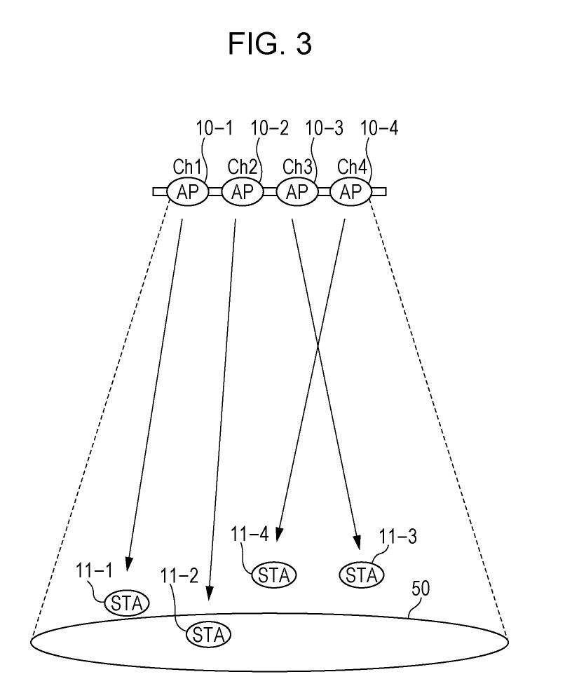

FIG. 3 is a diagram illustrating a relationship between the four base stations 10-1 to 10-4 and the four terminal stations 11-1 to 11-4 in the wireless communication system 1 according to the embodiment. In FIG. 3, the four base stations 10-1 to 10-4 are located so as to cover substantially the same area 50. The maximum allowable number of base stations is equal to the number of channels (4 channels) allowed to be used in the frequency band, and thus the maximum allowable number of base stations is four in this specific example. Basically, the four base stations 10-1 to 10-4 use different channels in operation.

The base station 10-1 uses the channel Ch1, the base station 10-2 uses the channel Ch2, the base station 10-3 uses the channel Ch3, and the base station 10-4 uses the channel Ch4.

At least one or more terminal stations are connected to each of the four base stations 10-1 to 10-4, and a plurality of terminal stations connected to the same base station perform communication by time-division multiplexing. Therefore, at any particular time, only one of the terminal stations connected to the same base station is allowed to communicate with that base station. In the following explanation, for simplicity, it is assumed that the number of terminal stations connected in each channel is equal to 1.

More specifically, the base station 10-1 communicates with the terminal station 11-1, the base station 10-2 communicates with the terminal station 11-2, the base station 10-3 communicates with the terminal station 11-3, and the base station 10-4 communicates with the terminal station 11-4. Note that data communication between the four base stations 10-1 to 10-4 and the terminal stations 11-1 to 11-4 connected to the respective base stations 10-1 to 10-4 occurs at the same time.

The four base stations 10-1 to 10-4 each have a function of changing the beam. The four terminal stations 11-1 to 11-4 each have each have a function of returning quality information acquired via the beam forming training to the base stations 10-1 to 10-4. The four base stations 10-1 to 10-4 each may change the beam mainly by one of methods described below (further details thereof are not specified herein):

(1) switching antennas;
(2) switching sectors; and
(3) using a phased array.

The base station 10-1 is notified in advance of the number of beam patterns of each of the other base stations 10-2 to 10-4. When the base station 10-1 performs the beam forming training, the base station 10-1 notifies the adjacent base stations 10-2 to 10-4 of the start of the beam forming training.

Alternatively, the base station 10-1 may perform a negotiation in advance with the other base stations 10-2 to 10-4 in terms of the start of the beam forming training. After an arbitration in terms of the bandwidth control is achieved, the beam forming training may be started synchronously. The determination as to whether the beam forming training is to be started (whether it is necessary to start the beam forming training) may be performed based on a determination as to whether degradation in communication quality occurs or whether timeout occurs, or based on other factors that are not prescribed here.

Parameters used in synchronously performing the beam forming training are also notified. The notified parameters may include, for example, the following:

(1) training start time;
(2) the number of training frames to be transmitted;
(3) training period information;
(4) training type;
(5) beam pattern order (clockwise, counter clockwise, random, or the like);
(6) frame type/frame length;
(7) transmission MCS; and
(8) restriction on transmission pattern.

The parameters (2) and (3) are calculated from the number of beams of the respective base stations 10-1 to 10-4 as described below. The parameter (4) specifies, for example, transmission training or reception training. The notification or the synchronization may be performed via a wired communication or other arbitrary communication such as Wi-Fi (registered trademark) communication using a microwave band, Bluetooth (registered trademark) communication, FeliCa (registered trademark) communication, Transfer jet (registered trademark) communication, or the like.

Each of the base stations 10-1 to 10-4 starts the beam forming training with the corresponding one of the terminal stations 11-1 to 11-4 connected (or to be connected) to the base station. Each of all four base stations 10-1 to 10-4 has three beam patterns, and thus as many training frames as 3×3×3×3=81 frames are transmitted.

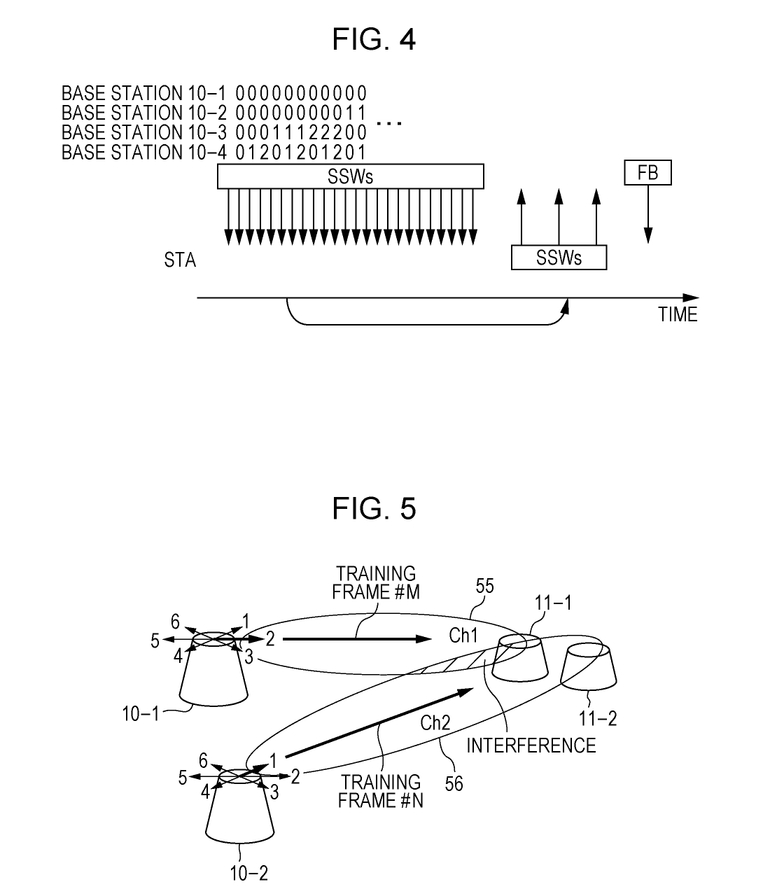

On the other hand, in a case where the four base stations 10-1 to 10-4 are different in the number of beam patterns, for example, in a case where the base station 10-1 has one beam pattern, the base station 10-2 has three beam patterns, the base station 10-3 has five beam patterns, and the base station 10-4 has seven beam patterns, the number of training frames is given as 1×3×5×7=105 frames. FIG. 4 is a diagram illustrating a beam forming sequence using SLS for a case in which each of all four base stations 10-1 to 10-4 has three beam patterns.

After the beam forming training is started, the base stations 10-1 to 10-4 transmit training frames synchronously. In the beam forming training performed here, when a frame transmitted by a certain base station (for example, the base station 10-1) is the same as that transmitted in an adjacent channel and the direction is similar, there is a high probability that interference occurs with a frame transmitted from another base station (for example, the base station 10-2).

FIG. 5 is a diagram illustrating an example of interference between a communication area 55 for a pair #1 of the base station 10-1 and the terminal station 11-1 and a communication area 56 for a pair #2 of the base station 10-2 and the terminal station 11-2. In FIG. 5, the base station 10-1 transmits a training frame #M to the terminal station 11-1 using a channel Ch1 and the base station 10-2 transmits a training frame #N using a channel Ch2 adjacent to the channel Ch1. In this situation, the communication area 55 for the pair #1 and the communication area 56 for the pair #2 partially overlap.

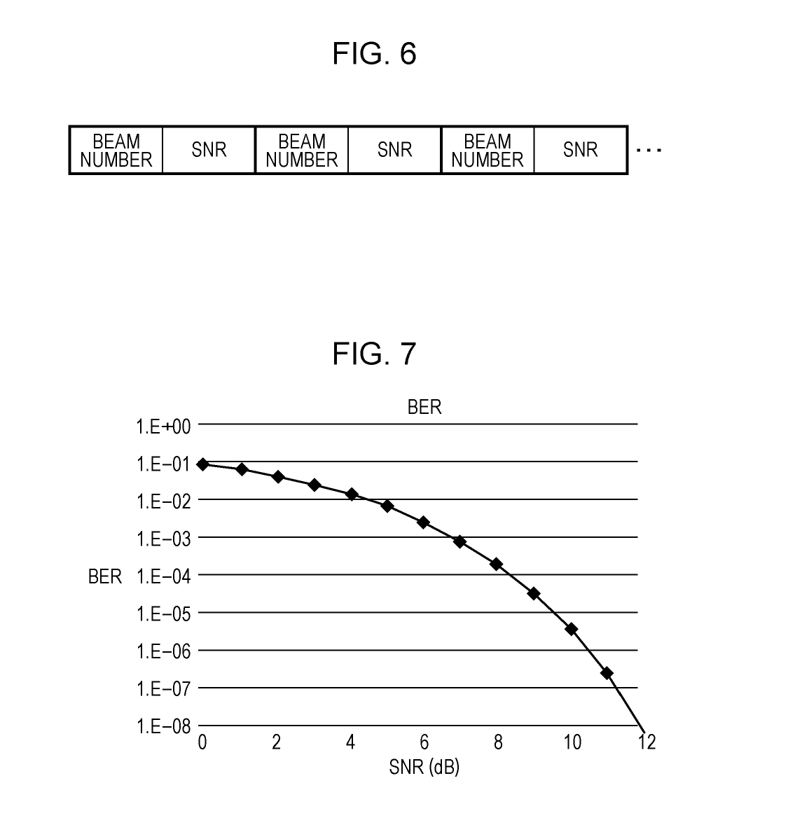

The terminal stations 11-1 to 11-4 in the communication areas supported by the respective base stations 10-1 to 10-4 report, using response frames, results of reception of the training frames. The terminal stations 11-1 to 11-4 also report results of reception of training frames including an interference state. Basically, the result of reception includes information representing the signal to noise ratio (SNR) measured in the channel used. FIG. 6 is a diagram illustrating an example of a response frame. In the example illustrated in FIG. 6, the response frame includes information representing a beam number and an SNR.

In a case where there is interference, when the interference is not recognized as a signal, the interference is measured as noise, and thus the SNR can be used as a measurement index including an influence of interference. In a case where it is possible to measure interference separately from noise, a signal to noise and interference ratio (SINR) defined as a ratio of the signal to noise plus interference may be evaluated, and the SINR may be used instead of the SNR.

The notified results (each including the beam number and the SNR) of the terminal stations 11-1 to 11-4 received by the respective base stations 10-1 to 10-4 are collected at the base station 10-1. After the notified results are collected at the base station 10-1, the base station 10-1 selects, based on the information on the beam numbers and the SNRs, a combination of beams that allows it to achieve a best overall performance of the four base stations 10-1 to 10-4.

As for the overall performance, the sum of throughputs of the respective base stations 10-1 to 10-4 (hereinafter, referred to as a system throughput) is used. Alternatively, a performance index determined taking further in account an error rate or a delay may be employed, or a performance index other than the throughput may be employed. Note that the performance index is determined without directly taking into account whether a selected combination of beams causes interference. Even when interference occurs for a combination of beams, if the combination of beams satisfies the condition described above, the combination of beams may be selected.

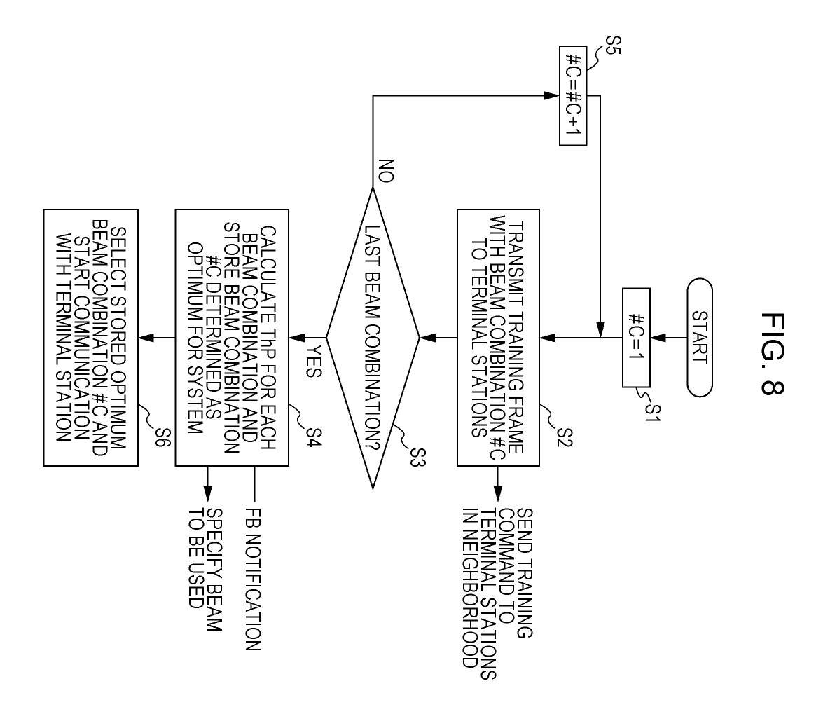

The SNR has a clear correlation with the error rate. FIG. 7 is a diagram illustrating an example of a performance in terms of the bit error rate (BER) vs. the SNR when binary phase shift keying (BPSK) is used. When the error rate is given, it is possible to approximately calculate a value of the throughput. Therefore, it is possible to estimate the throughput from the measured SNR value.

The base station 10-1 notifies the other base stations 10-2 to 10-4 of the selected combination of beams that provides the maximum system throughput. Also this notification may be performed via a wired communication or other arbitrary communication such as Wi-Fi (registered trademark) communication using an undirectional band, Bluetooth (registered trademark) communication, FeliCa (registered trademark) communication, Transfer jet (registered trademark) communication, or the like.

Using the selected beams, the respective base stations 10-1 to 10-4 performs data communication with corresponding terminal stations 11-1 to 11-4 which are under the control of the respective base stations 10-1 to 10-4 and from which the notification has been received.

FIG. 8 is a flow chart illustrating a method of beam forming training performed in the wireless communication system 1 according to the embodiment. In FIG. 8, when the beam forming training with the terminal stations 11-1 to 11-4 of interest is started, a beam combination number #C is set to 1 (#C=1) (step S1).

Next, using the beam combination number (#C=1), a training frame is transmitted to the terminal stations 11-1 to 11-4 (step S2). Next, a determination is performed as to whether the beam combination is a last one (step S3). In a case where the beam combination is not a last one (that is, the answer to step S3 is “No”), the beam combination number is incremented such that #C=#C+1 (step S5).

Thereafter, the process in step S2 is repeated. On the other hand, in a case where the beam combination is a last one (that is, the answer to step S3 is “Yes”), ThP (throughput) of the system is calculated for each combination of beams, and an optimum beam combination number #C that provides the best ThP of the system is stored (step S4). The stored optimum beam combination number #C is then selected, and communication with the terminal station 11 of interest is started (step S6).

That is, the four base stations 10-1 to 10-4 transmit training frames corresponding to the beam combination number #C=1. The beam combination number #C=1 is a combination of system (1) (0000) as illustrated in FIG. 2. In this case, the training frame of the pattern #1 of the three patterns #1 to #3 is transmitted from all base stations 10-1 to 10-4.

Next, training frames of the beam combination number #C=#C+1 are transmitted. The beam combination number #C=#C+1 is a combination of system (2) (0001) as illustrated in FIG. 2. In this case, the training frame of the pattern #1 of the three patterns #1 to #3 is transmitted from three base stations 10-1 to 10-3, and a training frame of the pattern #2 is transmitted from one base station 10-4.

Next, training frames of the beam combination number #C=#C+2 are transmitted. The beam combination number #C=#C+2 is a combination of system (3) (0002) as illustrated in FIG. 2. In this case, the training frame of the pattern #1 of the three patterns #1 to #3 is transmitted from three base stations 10-1 to 10-3, and a training frame of the pattern #3 is transmitted from one base station 10-4.

Next, training frames of the beam combination number #C=#C+3 are transmitted. The beam combination number #C=#C+3 is a combination of system (4) (0010) as illustrated in FIG. 2. In this case, the training frame of the pattern #1 of the three patterns #1 to #3 is transmitted from three base stations 10-1, 10-2, and 10-4, and a training frame of the pattern #2 is transmitted from one base station 10-3.

Similarly, training frames of patterns #1 to #3 are transmitted from the four base stations 10-1 to 10-4 for respective combinations of systems (5) to (81). Thereafter, using a combination of beams that provides a best system throughput, communication is performed between the respective four base stations 10-1 to 10-4 and corresponding four terminal stations 11-1 to 11-4. As described above, the best combination of beams is detected, and communication with the corresponding terminal stations 11-1 to 11-4 is performed using the detected best combination of beams, and thus the wireless communication system is capable of providing high-quality communication even in a state in which interference occurs.

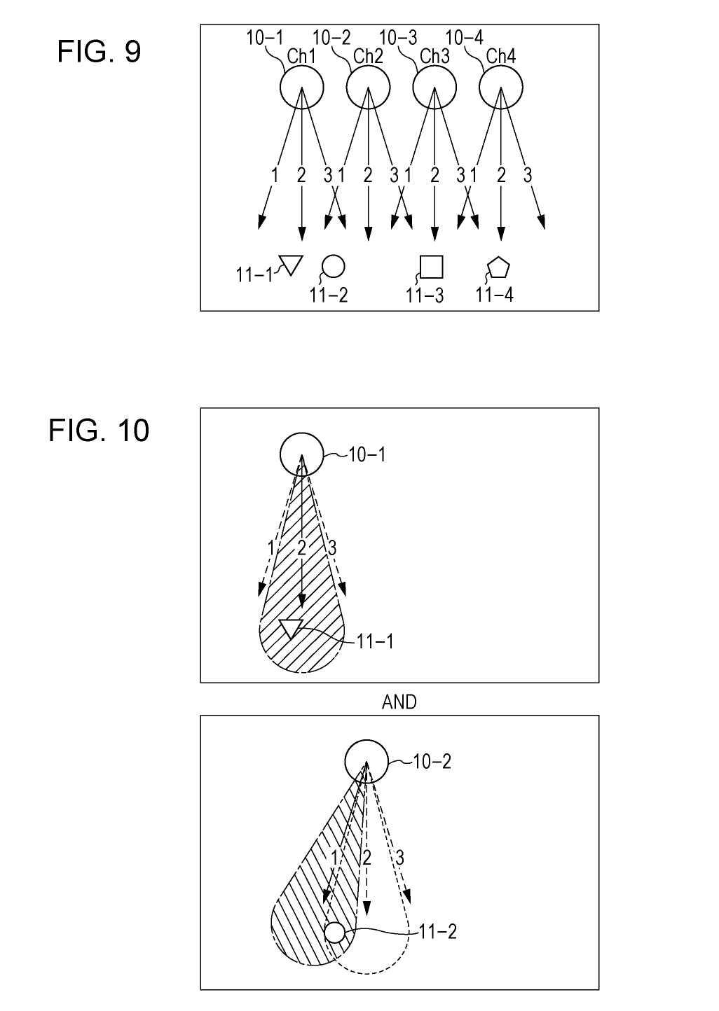

FIGS. 9 to 12 are diagrams illustrating examples of effects compared with that obtained in a conventional wireless communication system. In FIG. 9, the base stations 10-1 to 10-4 each have three patterns (that is, three beam directions). The terminal stations 11-1 to 11-4 are located as illustrated in FIG. 9. In FIG. 10, the base station 10-1 and the base station 10-2 perform beam forming training according to the conventional method and select optimum patterns. The base station 10-1 selects the pattern #2 and the base station 10-2 selects the pattern #1. For the base station 10-2, the pattern #1 is the best one, although the pattern #2 is good enough.

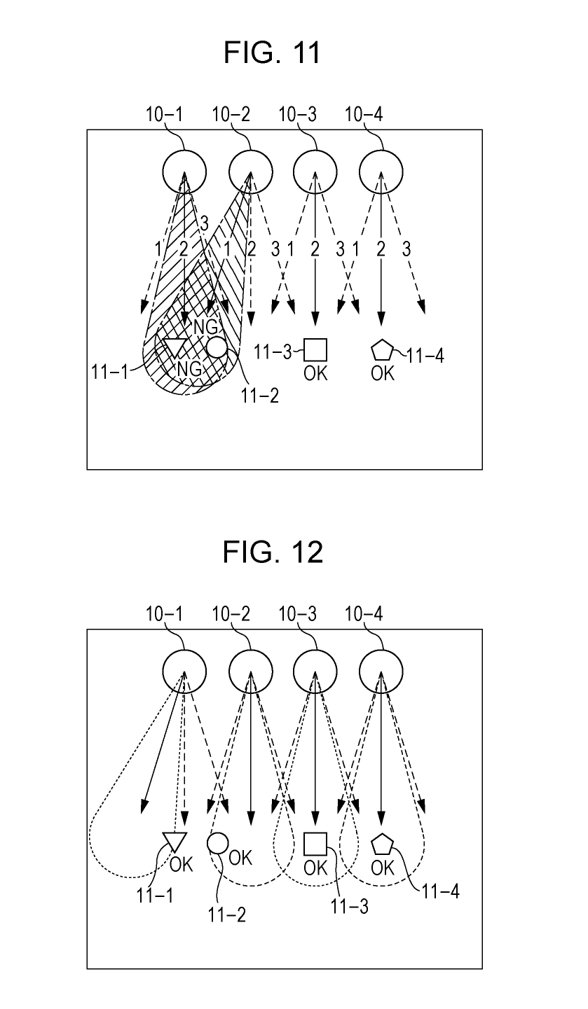

FIG. 11 illustrates overlap between the pattern #2 used by the base station 10-1 and the pattern #1 used by the base station 10-2. Because the beam patterns of the base station 10-1 and the base station 10-2 overlap, interference occurs. The interference makes it difficult to perform communication between the terminal stations 11-1 and 11-2 and the base stations 10-1 and 10-2. In a case where SNR=0 dB at the terminal station 11-1, SNR=0 dB at the terminal station 11-2, SNR=12 dB at the terminal station 11-3, and SNR=12 dB at the terminal station 11-4, and estimated throughputs are 0 Mbps when SNR=0 dB, 800 Mbps when SNR=8 dB, 1000 Mbps when SNR=10 dB, and 1200 Mbps when SNR=12 dB, then the total throughput is 2400 Mbps.

In contrast, in the wireless communication system 1 according to the embodiment, as illustrated in FIG. 12, the base station 10-1 selects the pattern #1 and the base station 10-2 selects the pattern #2, and thus the interference between the base station 10-1 and the base station 10-2 is suppressed. The suppression in interference makes it possible to perform communication between the respective terminal stations 11-1 and 11-2 and the base stations 10-1 and 10-2. Herein in a case where SNR=8 dB at the terminal station 11-1, SNR=10 dB at the terminal station 11-2, SNR=12 dB at the terminal station 11-3, and SNR=12 dB at the terminal station 11-4, then the total throughput is 4200 Mbps. That is, although the total throughput of the wireless communication system according to the conventional technique is only 2400 Mbps, the total throughput of the wireless communication system according to the present disclosure is as high as 4200 Mbps.

In the wireless communication system, it may be better to use a channel for communication if interference can be suppressed to an acceptable low level than not to use the channel at all. In the wireless communication system, when a SN value equal to or greater than a threshold value is ensured, a beam may be changed to avoid an interference wave thereby providing more communication channels. In the wireless communication system, even in a case where an optimum beam is not selected for each base station, it is possible to improve the overall communication quality.

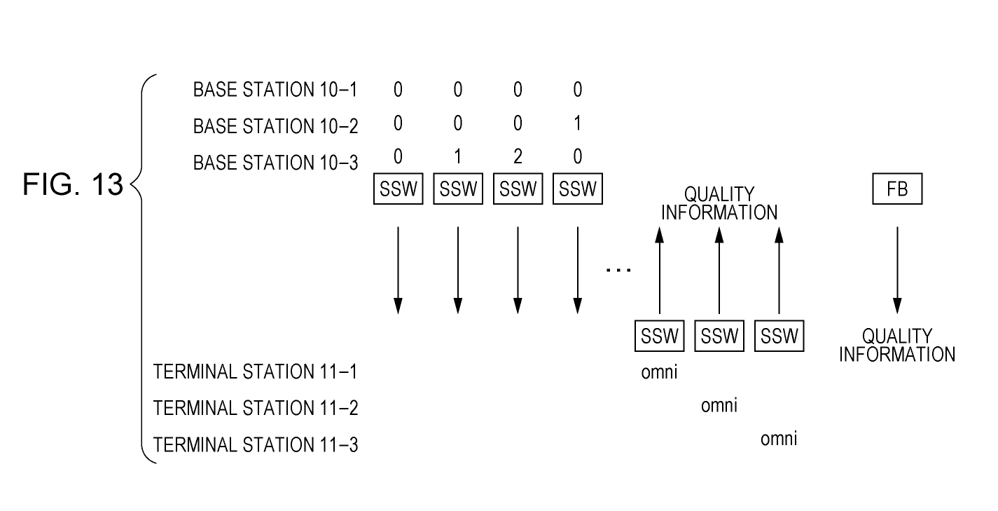

FIG. 13 is a diagram illustrating a method of performing beam forming training in the wireless communication system 1 according the embodiment. The wireless communication system 1 according to the embodiment perform the beam forming training for a combination of beams assigned to the respective base stations.

More specifically, in the wireless communication system 1 according to the embodiment, the plurality of combinations of beams for the respective four base stations 10-1 to 10-4 are selectively switched and training frames are transmitted, synchronously and sequentially, to the corresponding four terminal stations 11-1 to 11-4. Based on the result of reception of the transmitted training frames, the combinations of beams of the four base stations 10-1 to 10-4 are stored.

In the wireless communication system 1 according to the embodiment, a combination of beams that provides a highest overall performance of the wireless communication system 1 is selected from the stored combinations of beams for the four base stations 10-1 to 10-4. Using the selected combination of beams, communication is performed between the respective four base stations 10-1 to 10-4 and the corresponding four terminal stations 11-1 to 11-4. This makes it possible to suppress interference between adjacent channels thereby making it possible to achieve high-quality communication even in a situation in which the four channels Ch1 to Ch4 are used at the same time in communication between the four base stations 10-1 to 10-4 and the four terminal stations 11-1 to 11-4.

### First Example of Application

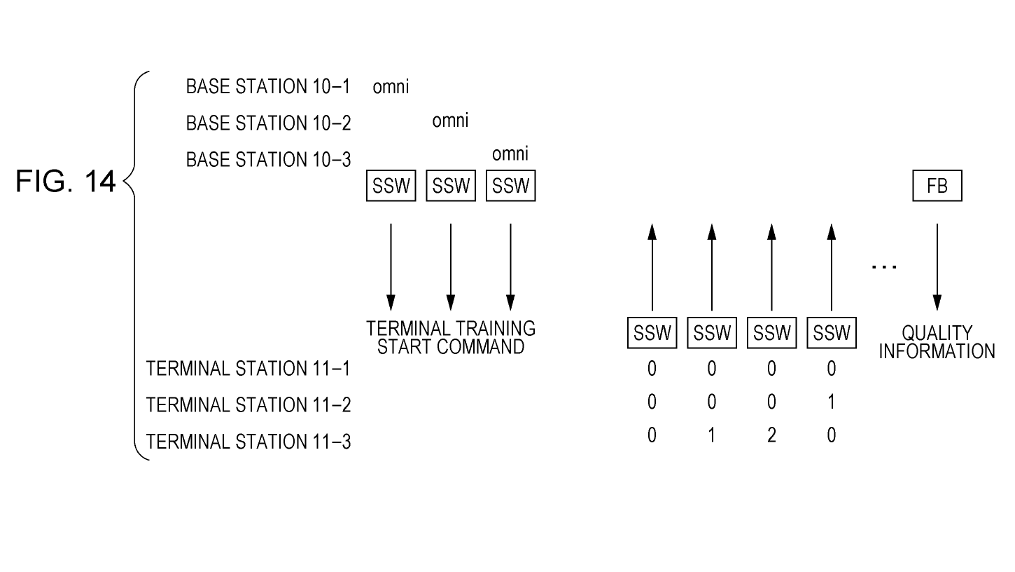

Combining of beams may be performed on a terminal station side, and transmission beam forming training may be performed using response SSW frames transmitted from terminal stations. FIG. 14 is a diagram illustrating a method of performing beam forming training in the wireless communication system 1 according to the first example of an application of the embodiment.

This makes it possible to, in terminal station communication, select an optimum beam taking into account also interference caused by transmission from terminal stations. When the base stations transmit SSW frames to corresponding terminal stations located in areas supported by the respective base stations, the terminal stations are notified that the terminal stations are to combine beams and perform transmission.

### Second Example of Application

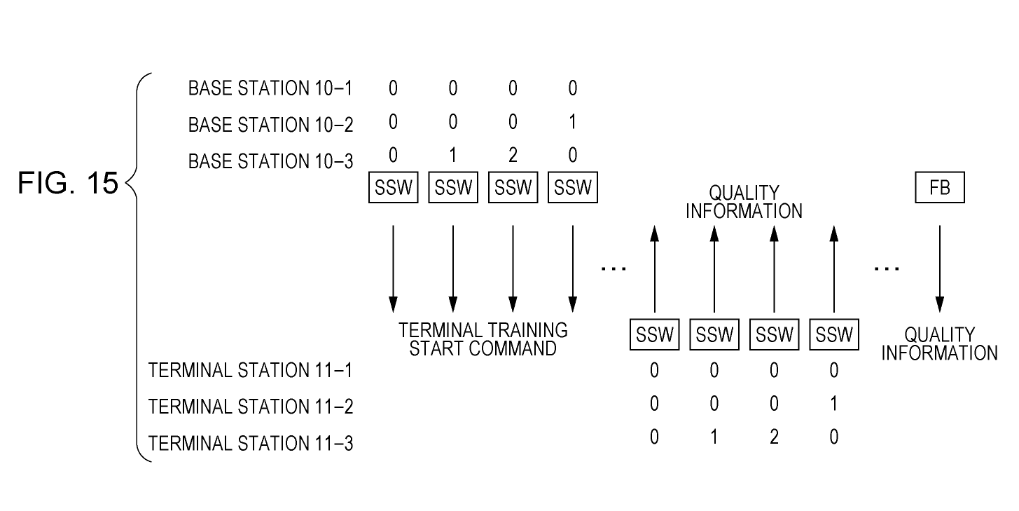

The transmission beam forming training may be performed such that combining of beams is performed in both base station transmission and terminal station transmission and the transmission beam forming training is completed by performing the training only once using respective SSW frames for training between base stations and for training between terminal stations. FIG. 15 is a diagram illustrating a method of performing beam forming training in the wireless communication system 1 according to the second example of an application of the embodiment.

This makes it possible, in communication initiated from a base station and in communication initiated from a terminal, to select an optimum combination of beams taking into account also interference between transmissions from base stations and interference between transmission from terminal stations. When the base stations transmit SSW frames to the corresponding terminal stations located in area supported by the respective base stations, the terminal stations are notified that the terminal stations are to combine beams and perform transmission.

### Third Example of Application

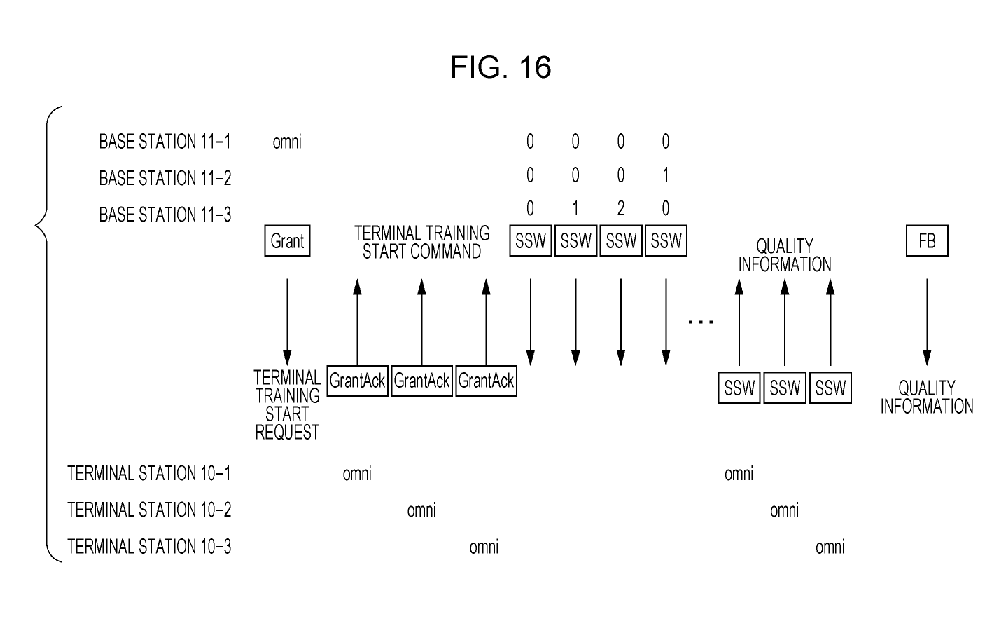

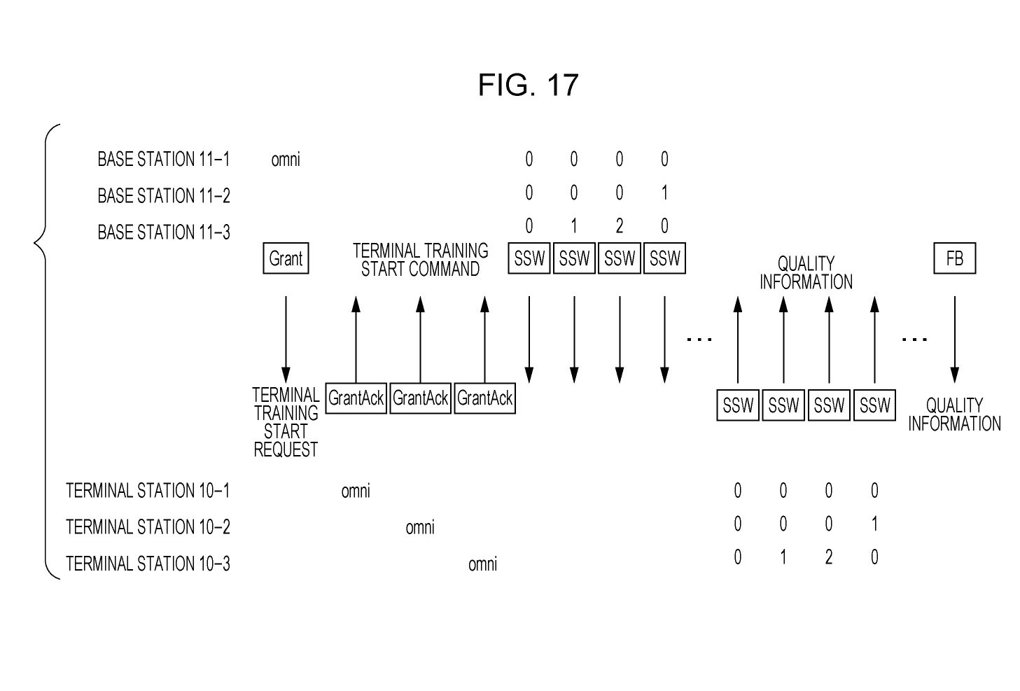

A base station may command terminal stations and base stations to perform transmission beam forming training sequentially in the order from the terminal stations to the base stations. In this specific example, Grant frames are used to send a start request, and Ransack frames are used to send a start command. FIG. 16 and FIG. 17 are diagrams illustrating a method of performing beam forming training in the wireless communication system 1 according to the third example of an application of the embodiment. This method is useful, for example, in a case where a terminal station triggers the start of the beam forming training when the terminal station detects degradation in communication quality.

### Fourth Example of Application

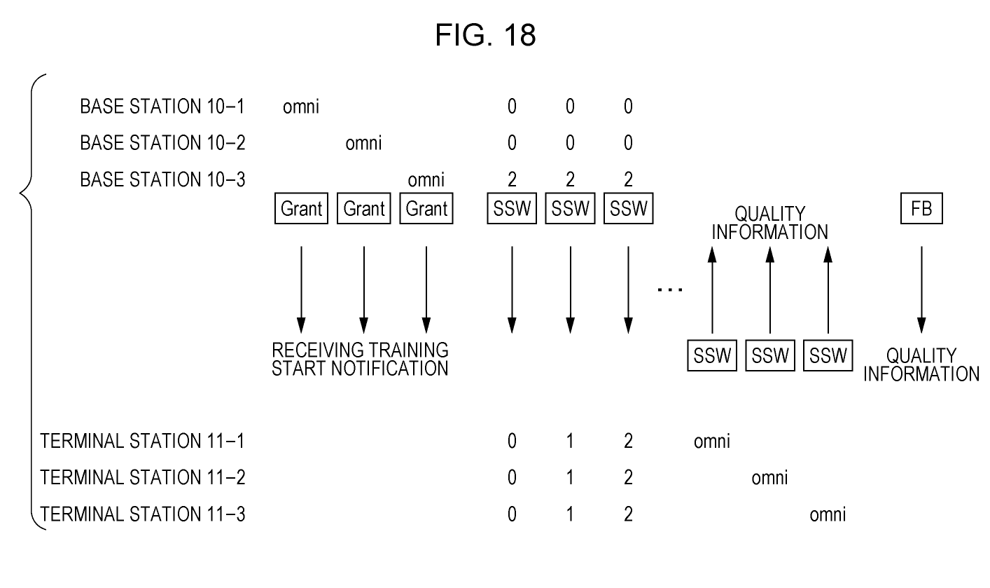

After the combination of transmission beams is determined taking into account the state of interference via the procedure described above, reception beam forming training may be performed at each base station and terminal station. FIGS. 18 to 21 are diagrams illustrating examples of methods of performing beam forming training in the wireless communication system 1 according to the fourth example of an application of the embodiment.

In the following description with reference to FIGS. 18 to 21, it is assumed by way of example that there are three base stations and three terminal station, and three channels are used. Note that the beam forming training may be performed in a similar manner and similar effects may be obtained also in a case where there are four base stations and four terminal stations and four channels are used.

In the example illustrated in FIG. 18, the combination of beams on the transmission side (the base stations) is fixed and the combination of beams on the reception side (the terminal stations) is varied. For example, using the result of the transmission beam training performed in advance in the above-described manner, the combination of beams for the three base stations 10-1 to 10-3 is fixed, and training frames are synchronously transmitted a plurality of times to the three terminal stations 11-1 to 11-3.

In this specific example, after the base stations 10-1 to 10-3 sequentially transmit a reception training start notification using an omnidirectional pattern, the base stations 10-1 to 10-3 transmit SSW frames using the combination (002) of transmission beams determined taking into account the state of interference, that is, the base station 10-1 uses the pattern #1, the base station 10-2 uses the pattern #1 and the base station 10-3 uses the pattern #3.

The three terminal stations 11-1 to 11-3 selectively switch the plurality of combinations of reception beams in synchronization with the training frames (SSW frames) transmitted from the three base stations 10-1 to 10-3, and store the combinations of beams for the three terminal stations 11-1 to 11-3 based on the obtained reception result (quality information).

In this specific example, each time a SSW frame is received, the terminal stations 11-1 to 11-3 switch the combination of beam patterns sequentially in the order (000), (111), and (222). Reception results (quality information) obtained at the respective terminal stations 11-1 to 11-3 are transmitted to the base stations 10-1 to 10-3 using the omni pattern.

In addition to the combination of transmission beams, the combination of reception beams is also selected so as to achieve a best overall performance of the wireless communication system 1, and the selected combination is used in the communication between the three base stations 10-1 to 10-3 and the corresponding three terminal stations 11-1 to 11-3 thereby making it possible to suppress interference between adjacent channels thus making it possible to achieve high-quality communication even in a situation in which the three channels Ch1 to Ch3 are used at the same time in communication between the three base stations 10-1 to 10-3 and the three terminal stations 11-1 to 11-3.

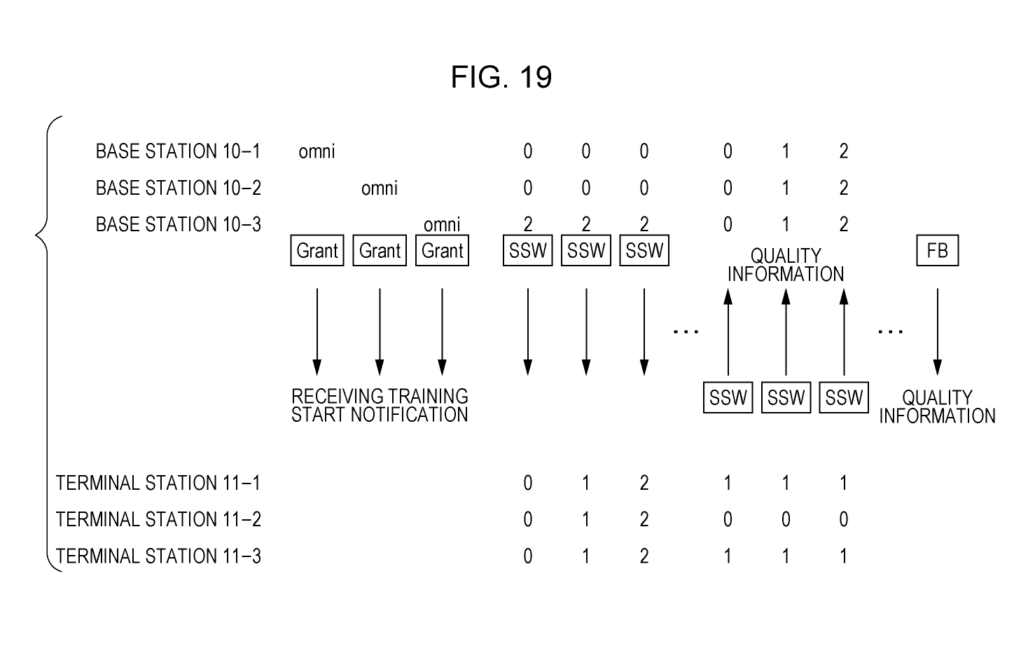

In the example illustrated in FIG. 19, as in the example illustrated in FIG. 18, training frames are transmitted such that the combination of beams on the transmission side (the base stations) is fixed and the combination of beams on the reception side (the terminal stations) is varied. On the other hand, when quality information is transmitted, the combination of beams on the transmission side (the terminal stations) is fixed and the combination of beams on the reception side (the base stations) is varied.

Thus, combining of beams is performed in both base station reception and terminal station reception, and the transmission beam forming training is completed by performing the training only once using respective SSW frames for training between base stations and for training between terminal stations. This makes it possible, in reception at a base station and in reception at a terminal, to select an optimum combination of beams taking into account also interference between transmissions from base stations and interference between transmission from terminal stations.

A terminal station may command terminal stations and base stations to perform reception beam forming training sequentially in the order from the terminal stations to the base stations. In this specific example, Grant frames are used to send a start request, and GrantAck frames are used to send a start command.

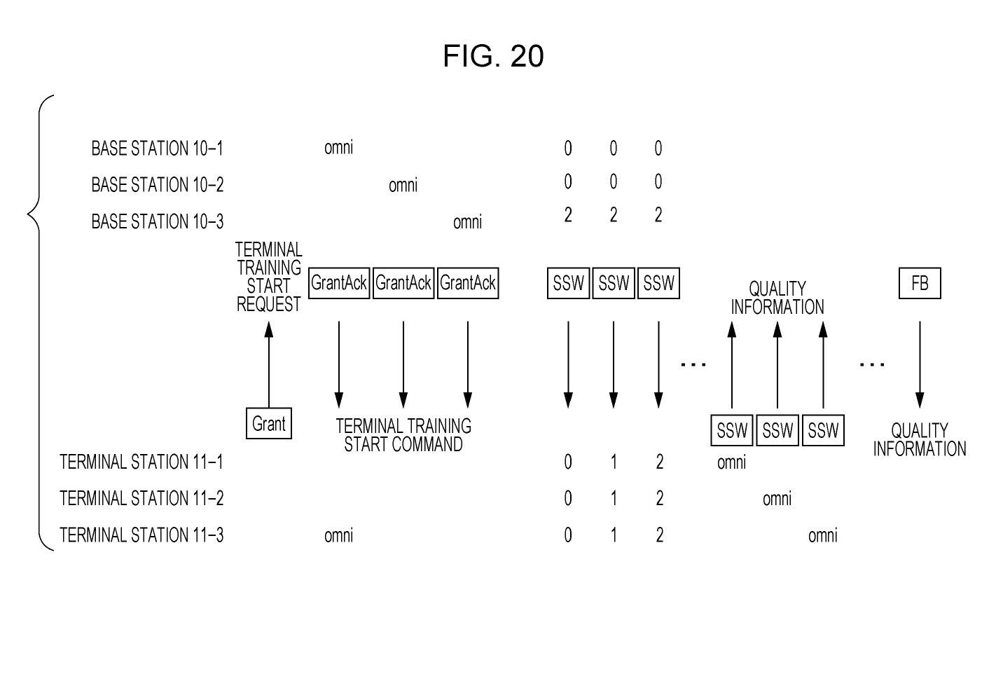

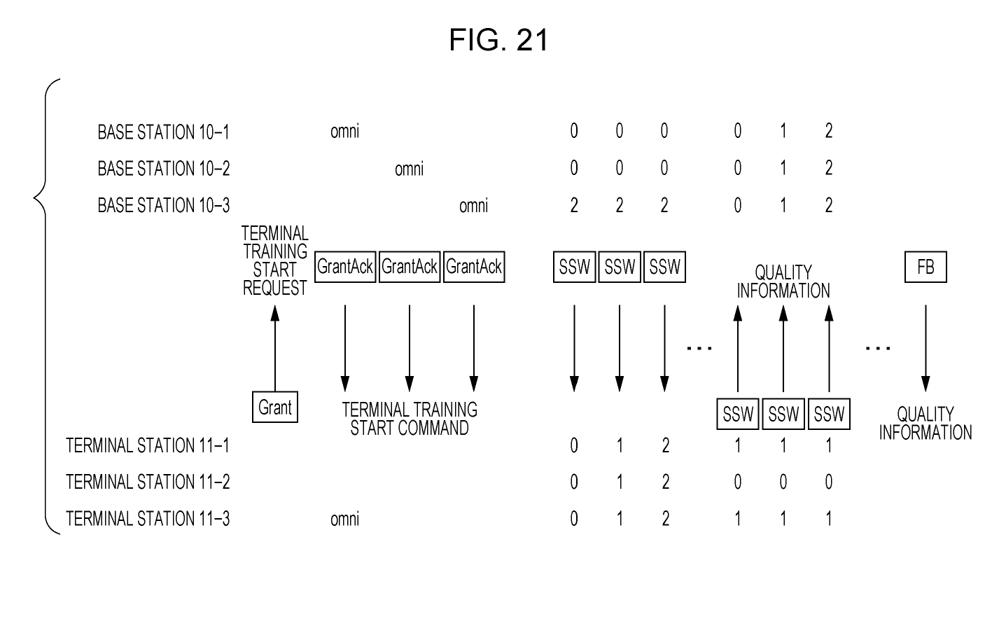

FIG. 20 illustrates a procedure of beam forming training similar to that illustrated in FIG. 18 except that a training start request is issued from the terminal station side. FIG. 21 illustrates a procedure of beam forming training similar to that illustrated in FIG. 19 except that a training start request is issued from the terminal station side. These procedures are useful in a case where a terminal station triggers the start of the beam forming training when the terminal station detects degradation in communication quality.

Note that in order to perform the reception beam forming training, the reception side needs to be capable of switching the receiving antennas, and the base stations transmit a reception antenna beam switch command to the terminal stations using Grant frames before the base stations transmit first SSW frames. The beams used in reception by the terminal stations in communication are specified by the base stations via the SSW frames or the FB frames transmitted to the terminal stations.

The procedure may be modified, for example, such that when transmission from base stations is performed, transmission beam forming training for the base stations and reception beam forming training for terminal stations are performed, and when transmission from the terminal stations is performed thereafter, transmission beam forming training for the terminal stations and reception beam forming training for the base stations are performed.

Thus, by performing the training only once, it is possible to select optimum combinations of antennas for both transmission antennas and reception antennas.

Furthermore, because it is possible to select a reception beam that provides higher quality based on the combination of transmission beams determined taking into account the interference state, it becomes possible to more efficiently use the frequency resource in the band usable by the wireless communication system.

Note that in the 60 GHz band, the reception antennas and the transmission antennas may be disposed separately. Furthermore, note that the number of transmission beams and the number of reception beams are not necessarily equal to each other, and the transmission beams and the reception beams are not necessarily symmetric in a directivity plane. During the process performed before the combination of beams is determined, it may be desirable to set the transmission beams and the reception beams to be omnidirectional to ensure that commands can be received. In the explanations described above, frames with names of SSW, Grant, and Ransack are used by way of example, but the names are not limited to those described above.

The number of combinations of transmission beams is simply given by the product of the numbers of beams, and thus the number of combinations is proportional to the number of beams. When the number of combinations is large, many SSW frames are transmitted and received. For example, in a case where one SSW frame has a width of 15 μs, when the number of combinations of beams is equal to 4096, it takes 15 μs×4096=61 ms to transmit 4096 combinations of beams in one run of beam forming training.

It takes a long time to transmit such a large number of combinations of beams using the above-described method. The number of combinations of beams varies depending on how often the beam forming training is performed. If it takes a long time to perform the beam forming training, a reduction occurs in time allowed to spend to perform communication, and thus it is desirable that the time spent to perform the beam forming training is as short as possible.

In view of the above, in a communication method according to the present disclosure, before the combination training is performed, when there is one or more beams predicted not to provide required communication quality such as a predetermined threshold value of SNR, such beams are removed in advance such that those beams are not included in the number of combinations of beams to be subjected to the beam forming training.

In this case, each base station first notifies the control unit 30 of the number of beams or patterns usable by the base station. Thus it is possible to reduce the time spent to perform the combination training, which makes it possible to more efficiently use the frequency resource in the band.

Alternatively, when a result of previous combination training predicts that one or more beams will not provide required communication quality such as a predetermined threshold value of SNR, such beams are excluded from next beam forming training. Thus it is possible to reduce the time spent to perform the combination training, which makes it possible to more efficiently use the frequency resource in the band.

When RSSI is large and SNR is small in evaluation of communication quality for a certain combination of beams, there is a high probability that interference occurs in such a combination and thus a reduction in communication quality occurs, and thus such a combination may be excluded from the combination training.

For example, in a case where a beam of a channel Ch4 is used by another base station, the influence of the channel Ch4 on the base stations and the terminal stations using the channels Ch1 and Ch2 that are not adjacent to the channel Ch4 is limited, and thus the channel Ch4 may be excluded from combinations for beam forming training for the channels Ch1 and Ch2.

In a case where the beam forming training is performed by a terminal station dedicated to communication performed in a bandwidth control service period (SP), the combination beam forming training may be performed for a base station or a terminal station that may be used in transmission in the SP period. This makes it possible to reduce the time spent to perform the combination training, which makes it possible to more efficiently use the frequency resource in the band.

In frames for transmitting a quality information notification, it is necessary to transmit information associated with a plurality of combinations as described above. In the example described above, it is necessary to transmit information associated with 4096 combinations. Instead of transmitting information associated with all measured combinations, notification information may be limited to that associated with a limited number (greater than 1 and smaller than the possible total number of combinations) of combinations specified by a base station.

This makes it possible to reduce the frame length used to transmit quality information notification, and thus it is possible to reduce the time spent to perform the beam forming training, which makes it possible to more efficiently use the frequency resource in the band. Alternatively, as many combinations as specified by a base station are selected in the order from the highest reception quality to lower reception quality, and notification information associated with the selected combinations may be transmitted. A description is omitted here on a specific method of calculating the number and a specific method of making the selection.

In a case where the control unit 30 predicts that the time to be spent to perform the sequence of combination beam forming training will be greater than a predetermined threshold, the combination training may be divided (fragmented) into a plurality of parts and they may be performed separately at particular intervals of time.

This makes it possible to suppress a data delay caused by the combination training within a particular range. Thus it is possible to suppress the delay even in video image streaming or similar data transmission. This makes it possible satisfy requirements for both the data transmission and the beam forming training.

In the present disclosure, in view of the present situation in Japan in terms of 60 GHz band, it is assumed by way of example that four channels are available in the 60 GHz band. When an improvement in the performance of wireless communication apparatuses is achieved in the future, for example, two channel bonding or the like may be used. Also in the state in which channel bonding is used, interference between adjacent or close channels can still occur. Therefore, the present disclosure will be useful also in such a future situation.

### First Example of Modification

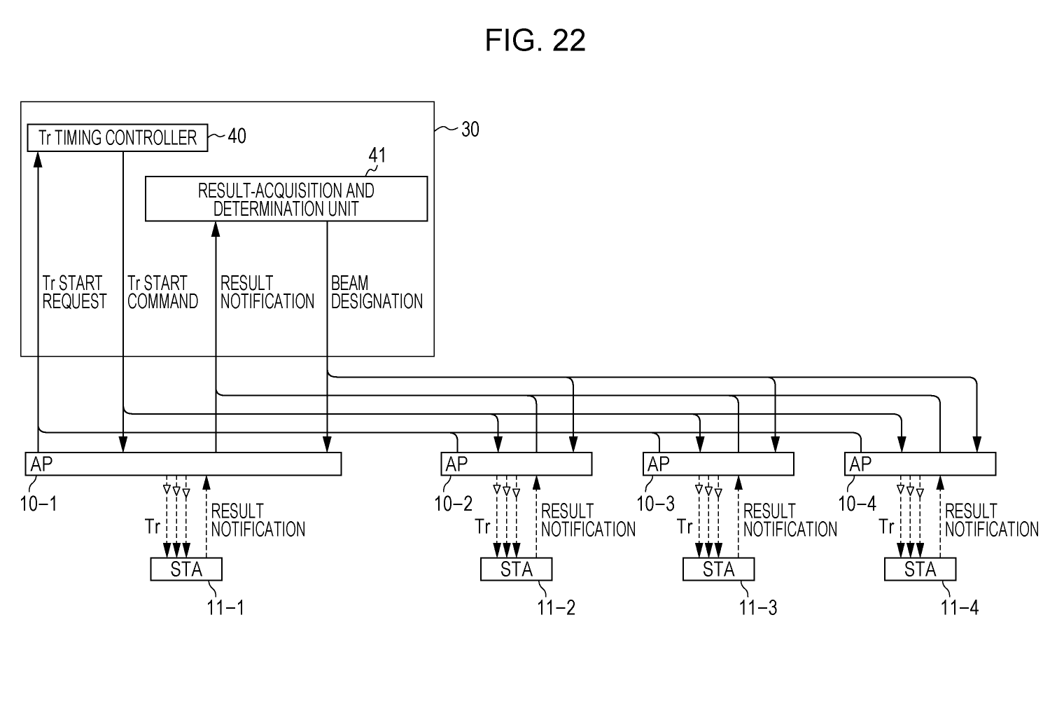

FIG. 22 is a block diagram illustrating a configuration of a first example of a modification of the wireless communication system 1 according to the embodiment. In the first example of a modification illustrated in FIG. 22, the control unit 30 is disposed separately in the outside of the base station 10-1. Also in the configuration illustrated in FIG. 22, it is possible to achieve effects similar to those achieved in the wireless communication system 1 according to the embodiment.

### Second Example of Modification

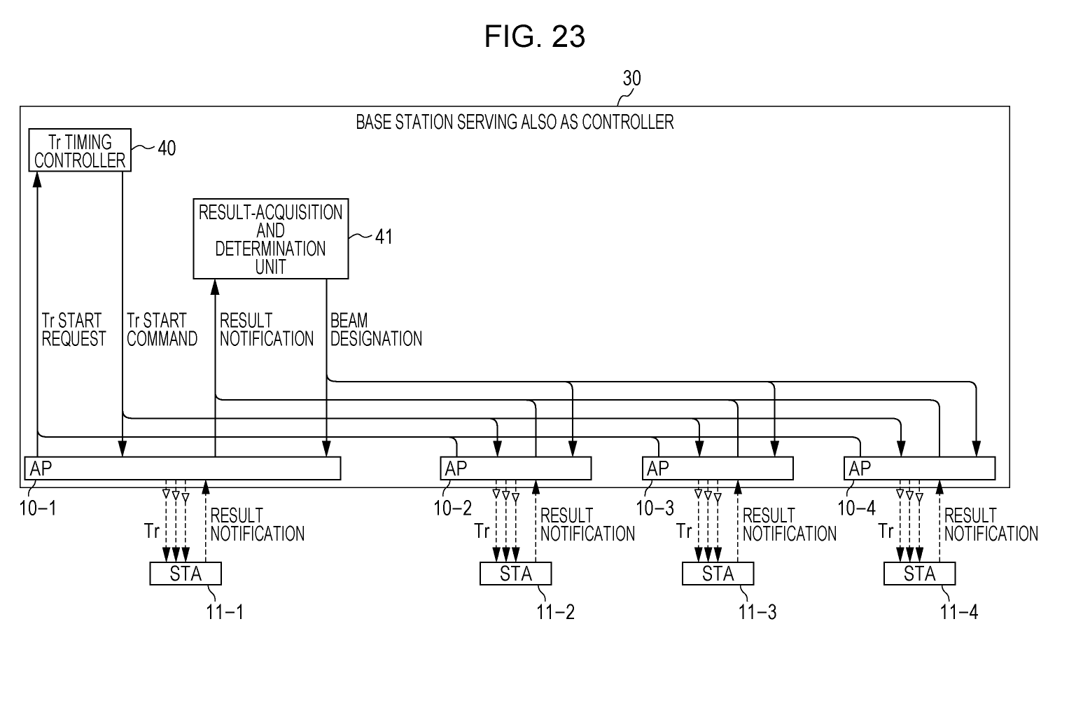

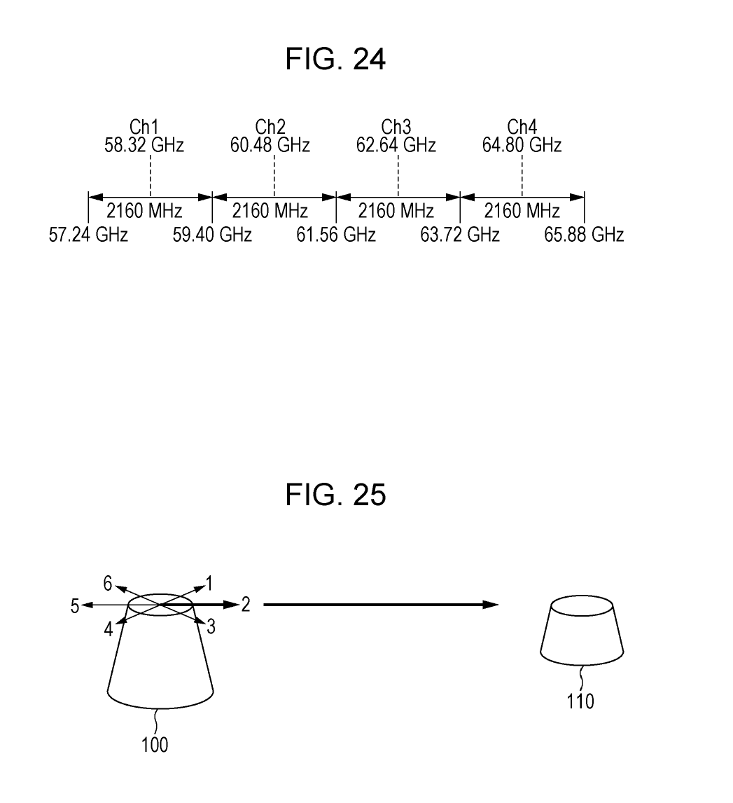

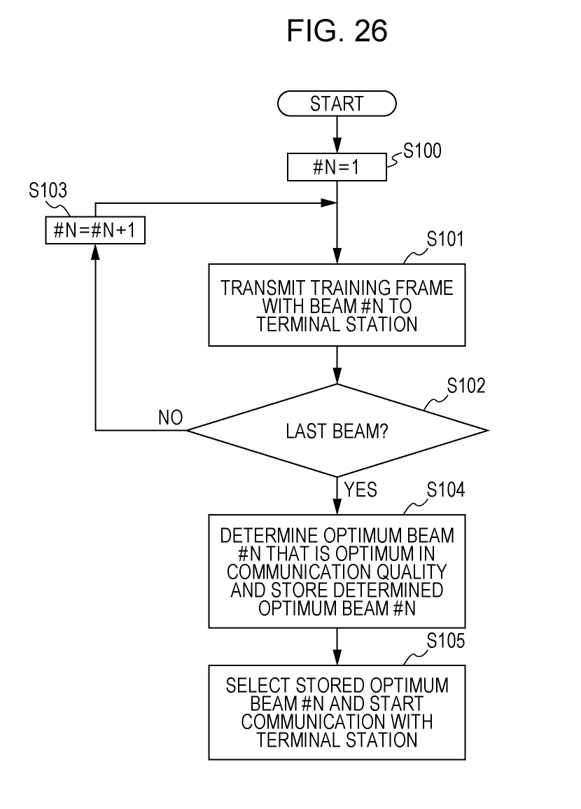

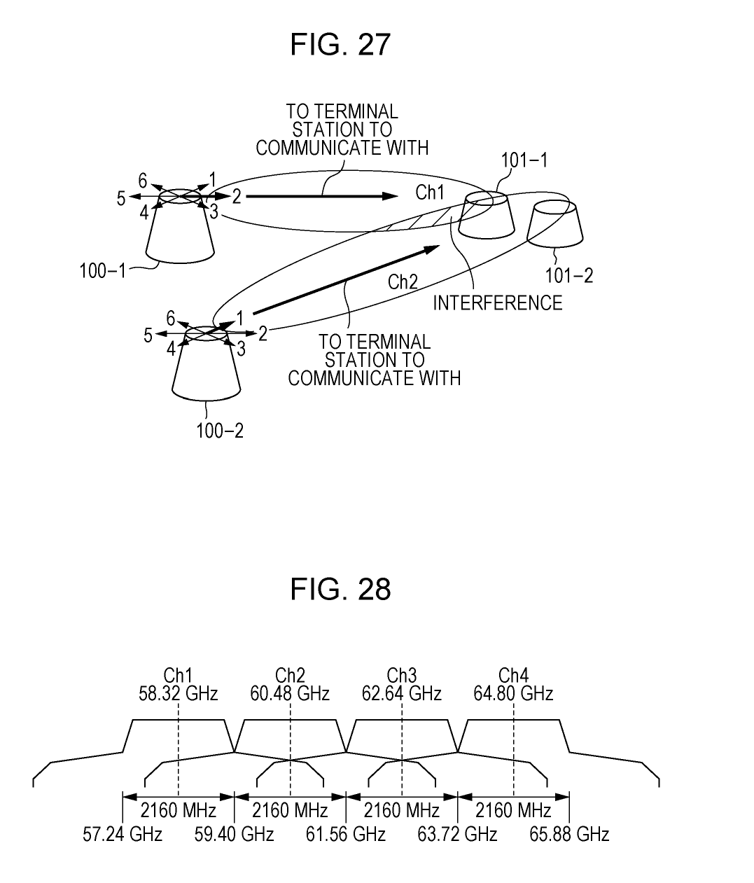

FIG. 23 is a block diagram illustrating a configuration of a second example of a modification of the wireless communication system 1 according to the embodiment. In the second example of a modification illustrated in FIG. 23, the control unit 30 and all base stations 10-1 to 10-4 are combined together. Also in the configuration illustrated in FIG. 23, it is possible to achieve effects similar to those achieved in the wireless communication system 1 according to the embodiment.

The present disclosure has been described above referring to exemplary embodiments and examples of applications in conjunction with drawings. Note that the present disclosure is not limited to those examples described above. It will be apparent to those skilled in the art that the disclosure may be modified in various ways without departing from the scope of the present disclosure. It should be understood that such modifications also fall in the scope of the present disclosure. Furthermore, elements of embodiments may be combined without departing from the scope of the present disclosure.

In the embodiments of the present disclosure described above, it is assumed by way of example that hardware is used to realize the present disclosure. Note that the present disclosure may also be realized by software in cooperation with hardware.

The respective functional blocks in the embodiments described above may be typically realized in the form of an LSI, which is one type of integrated circuit. In this case, each functional block may be individually formed on one chip, or part or all functional blocks may be formed on one chip. The form of the integrated circuit is not limited to the LSI, but various other types of integrated circuits such as an IC, a system LSI, a super LSI, an ultra LSI, and the like may be employed.

Furthermore, the type of the integrated circuit is not limited to the LSI, but other types of integrated circuits such as a dedicated circuit, a general-purpose processor, or the like may be employed. Another example of an usable integrated circuit is a field programmable gate array (FPGA) that is programmable after the integrated circuit is produced. A still another example is a reconfigurable processor that allows it to reconfigure connections among circuit cells in an LSI or reconfigure settings thereof

When a new integration circuit technique other than LSI techniques are realized in the future by an advance in semiconductor technology or related technology, the functional blocks may be realized using such a new technique. For example, there is a possibility that a new technique based on a biological technique will become usable.

### Summary of Aspects of Present Disclosure

According to an aspect of the present disclosure, there is provided a wireless communication method for performing communication between a respective plurality of base stations and a corresponding plurality of terminal stations, each base station having a plurality of beams and being capable of switching the plurality of beams, the method including selectively switching a combination of beams used by the respective base stations among a plurality of combinations of beams and transmitting, synchronously and sequentially, training frames to the plurality of terminal stations, storing information representing the plurality of combinations of beams for the plurality of base stations based on a result of reception of the training frames, and selecting, from the stored information representing the combinations of beams for the plurality of base stations, a combination of beams that provides a best overall performance of the plurality of base stations, and allowing it to perform communication to be performed between the plurality of base stations and corresponding terminal stations.

In the wireless communication method, the result of the reception of the training frames may include a beam number and an SN ratio.

In the wireless communication method, the overall performance of the plurality of base stations may be a sum of throughputs of the respective base stations.

According to an aspect of the present disclosure, there is provided a wireless communication system in which communication is performed between a plurality of base stations each having a plurality of beams and a plurality of terminal stations such that a beam is switched for communication between each base station and a corresponding terminal station, including a transmission unit that selectively switches a combination of beams used by the respective base stations among a plurality of combinations of beams and transmits, synchronously and sequentially, training frames to the plurality of terminal stations, a storage unit that stores information representing the plurality of combinations of beams for the plurality of base stations based on a result of reception of the training frames, and a communication unit that selects, from the stored information representing the combinations of beams for the plurality of base stations, a combination of beams that provides a best overall performance of the plurality of base stations, and allows it perform communication between the plurality of base stations and corresponding terminal stations.

The present disclosure provides techniques useful, for example, in applications in which ultrahigh-speed data transmission service using a millimeter wave communication device or the like is provided to a plurality of uses in a public space such as a station platform, a space in an airplane, or the like.

What is claimed is:

1. A wireless communication method for performing communication between a respective plurality of base stations and a corresponding plurality of terminal stations, each base station having a plurality of beams and being capable of switching the plurality of beams, the method comprising:
selectively switching a combination of beams used by the respective base stations among a plurality of combinations of beams and transmitting, synchronously and sequentially, training frames to the plurality of terminal stations;
storing information representing the plurality of combinations of beams for the plurality of base stations based on a result of reception of the training frames; and
selecting, from the stored information representing the combinations of beams for the plurality of base stations, a combination of beams that provides a best overall performance of the plurality of base stations, and allowing it to perform communication to be performed between the plurality of base stations and corresponding terminal stations.

2. The wireless communication method according to claim 1, wherein the result of the reception of the training frames includes a beam number and an SN ratio.

3. The wireless communication method according to claim 1, wherein the overall performance of the plurality of base stations is a sum of throughputs of the respective base stations.

4. A wireless communication system in which communication is performed between a plurality of base stations each having a plurality of beams and a plurality of terminal stations such that a beam is switched for communication between each base station and a corresponding terminal station, comprising:
a transmission unit that selectively switches a combination of beams used by the respective base stations among a plurality of combinations of beams and transmits, synchronously and sequentially, training frames to the plurality of terminal stations;
a storage unit that stores information representing the plurality of combinations of beams for the plurality of base stations based on a result of reception of the training frames; and
a communication unit that selects, from the stored information representing the combinations of beams for the plurality of base stations, a combination of beams that provides a best overall performance of the plurality of base stations, and allows it to perform communication to be performed between the plurality of base stations and corresponding terminal stations.
